(19) United States
(12) Patent Application Publication
(10) Pub. No.: US 2006/0147893 A1
(43) Pub. Date: Jul. 6, 2006

(54) Magnetic sheet display system and method of making the same

(76) Inventors: Gregory Moore, Belton, TX (US); John Hardt II, Belton, TX (US)

Correspondence Address: NATH & ASSOCIATES, 112 South West Street, Alexandria, VA, 22314, US

(21) Appl. No.: 11/201,187

(22) Filed: Aug. 11, 2005

Related U.S. Application Data
(63) Continuation-in-part of application No. 11/017,674, filed on Dec. 22, 2004.

(51) Int. Cl. G09B 29/00

(52) U.S. Cl. 434/430

(57) ABSTRACT

The present inventive subject matter relates to a magnetic display system that may be connected to a surface. More particularly, the present inventive subject matter relates to a magnetic display system that can have a fabric top layer and magnetic back layer, which may be connected to a surface such as a wall, chalkboard, or dry erase board.

### FIELD OF THE INVENTION

The present inventive subject matter relates to a magnetic display system that may be connected to a surface. More particularly, the present inventive subject matter can relate to a magnetic display system with a fabric top layer and magnetic back layer, which may be connected to a surface such as a wall, chalkboard, or dry erase board.

### BACKGROUND OF THE INVENTION

There are many well-known teaching aids available in the prior art. These include chalkboards, dry erase boards, flannel cloths, wood blocks, plastic blocks, magnetic blocks and foam-like blocks. Each of these teaching aids have advantages and disadvantages, including cost, size, and the availability of these devices to teachers and students. Some of these teaching aids can be intimidating to students because of their size and/or their location in a given room. Further, some of these aids include heavy, messy, expensive, and difficult to use components.

Educators have always desired obtaining and using teaching aids that are readily and easily available, as well as obtaining teaching devices which can be readily and easily available and used by students, in particular with younger more impressionable students. It is thought that the use of teaching devices that are easily handled and manipulated by the teacher and the students can enhance learning by, inter alia, encouraging participatory learning processes by students.

However, encouraging students to participate in learning exercises can sometimes be a daunting task to many educators. Moreover, many younger students, such as those students in pre-kindergarten, kindergarten, first, second, and third grades, can be intimidated easily by having to approach an education device, such as a chalkboard or dry erase board and having to perform a desired task on the device.

In an attempt to make learning easier and fun for these younger students, flannel boards and cork boards have been created. Flannel boards typically consist of a board covered with a flannel material in which flannel cut-outs can be placed thereon for education and illustration purposes. While cork boards typically consist of a board having a cork top layer in which tacks and other hanging devices can be pushed into. However, many of these boards only have a solitary use, which make them somewhat undesirable to many educators and school systems. For example, a flannel board may be great for interactive learning exercises, however, if an educator wants to lecture before a class, using a dry erase board or chalkboard is usually more efficient.

Due to rising education costs, and dwindling budgets, schools are forced to cut back and prioritize how money is spent every year. Thus, for many schools, the ability to purchase a standard chalkboard or dry erase board for a classroom is all the school can budget for. Such other preferable learning and education devices, such as an interactive flannel board or cork board, may not make the budget cuts.

Further, many schools and classrooms are becoming increasingly over populated. Many times, teachers barely have enough space for a standard chalkboard or dry erase board, let alone the space for a separate flannel board.

### SUMMARY OF THE INVENTION

Thus, it is highly desirable to condense the amount of learning and education devices needed, while also reducing the cost and space restrictions put in place by schools. Further, it is highly desirable to produce an easy to manipulate and light weight, teaching and education device, which can increase the learning of students, in particular that of pre-kindergarten, kindergarten, and early elementary grade level students.

The present inventive subject matter relates to a magnetic display system that may be connected to a surface. More particularly, the present inventive subject matter relates to a display system comprising a top layer, a middle section connected to the top layer, and a back layer connected to the middle section, wherein the top layer comprises at least one material selected from the group consisting of cork, vinyl, rubber, recycled rubber, and combinations thereof, and the back layer comprises a magnetic material.

The present inventive subject matter further relates to a display system comprising a top layer, a middle section connected to the top layer, and a back layer connected to the middle section, wherein the top layer comprises at least one material selected from the group consisting of cork, vinyl, rubber, recycled rubber, and combinations thereof, and the back layer comprises a peel-off backing layer.

Additionally, the present inventive subject matter relates to a display system comprising a top layer, a middle section, and a peel-off back layer connected to said middle section, wherein said middle section connected to said peel-off back layer is laminated to said top layer such that a bond between said top layer and said middle section is greater than a bond between said middle section and said peel-off back layer.

### BRIEF DESCRIPTION OF THE FIGURES

FIG. 1 is an illustration of a side view of an exemplary embodiment of a magnetic display system;

FIG. 2 is an illustration of a side view of another exemplary embodiment of a magnetic display system;

FIG. 3 is an illustration of a top view of an exemplary embodiment of a magnetic display system with a flexed corner;

FIG. 4 is an illustration of a top view of another exemplary embodiment of a magnetic display system with a flexed corner and attached visual characters thereto;

FIG. 5 is an illustration of an exemplary embodiment of a magnetic display system connected to a separate magnetic display system;

FIG. 6 is an illustration of another exemplary embodiment of a magnetic display system connected to separate magnetic display system;

FIG. 7 is an illustration of a lamination process for producing an exemplary embodiment of a magnetic display system.

### DETAILED DESCRIPTION OF THE INVENTION

The present inventive subject matter relates to a magnetic display system that may be connected to a surface. More particularly, the present inventive subject matter can relate to a magnetic display system with a fabric top layer and magnetic back layer, which may be connected to a surface such as a wall, chalkboard, or dry erase board.

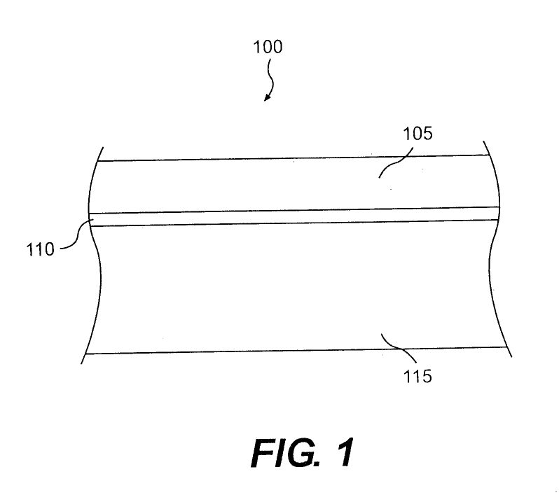

As shown in FIG. 1, an enlarged side view of an embodiment of a magnetic display system 100 has a top layer 105, a middle section 110 connected to the top layer 105, and a back layer 1 15 connected to the middle section 110.

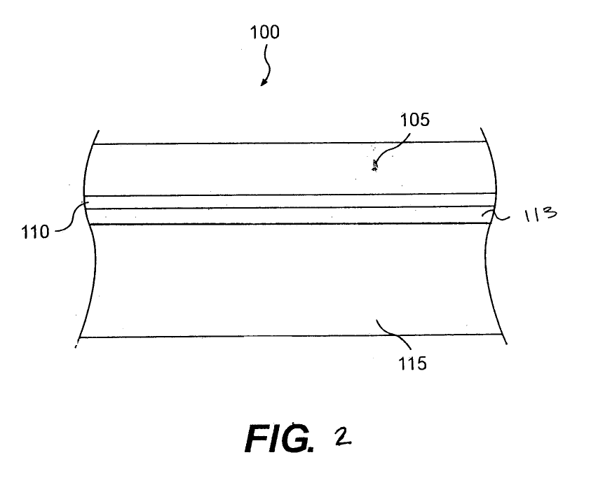

Turning now to FIG. 2, an enlarged side view of another embodiment of a magnetic display system 100 has a top layer 105, a middle section 110 connected to the top layer 105, and a back layer 115 having release coating 113 connected to middle section 110.

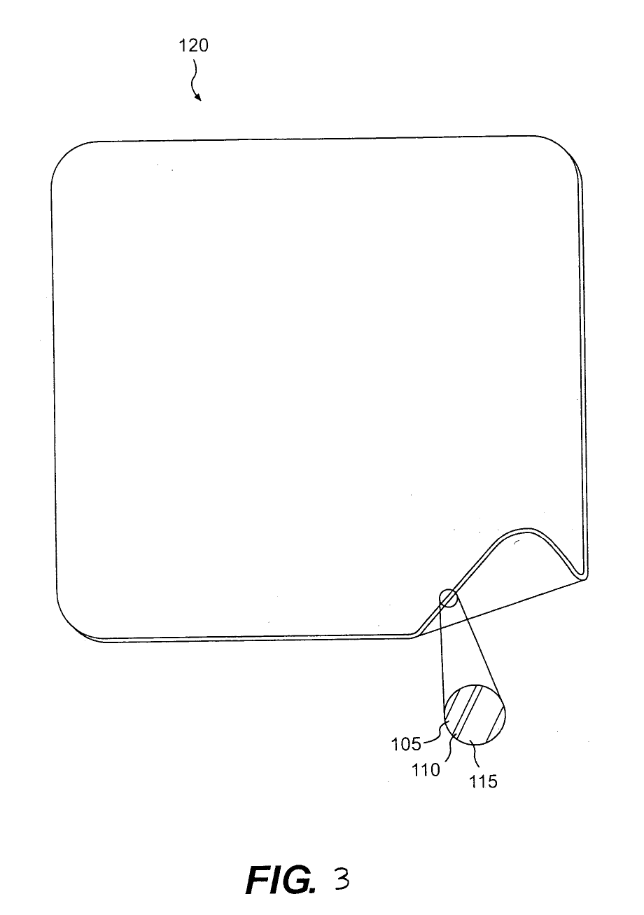

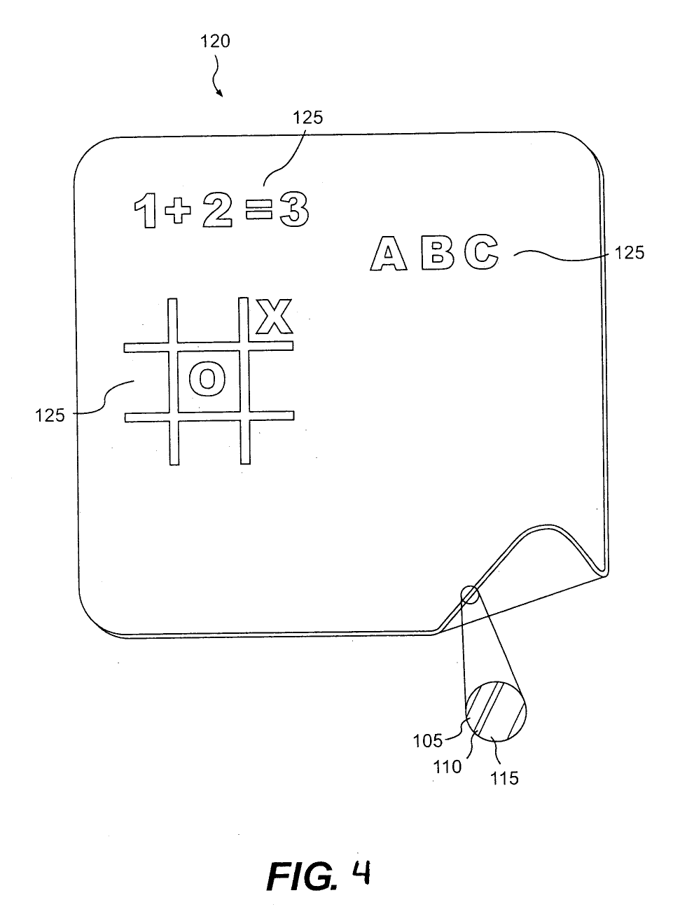

As shown in FIGS. 3 and 4, a top view of an embodiment of a magnetic display system 120 is depicted. As previously shown in FIG. 1, the magnetic display system 120 of FIGS. 2 and 3 has a top layer 105, a middle section 110 connected to the top layer 105, and a back layer 115 connected to the middle section 110. Also as shown in FIGS. 2 and 3, the corner of the magnetic display system 120 can be bent demonstrating the display systems optional pliable nature. Moreover, FIG. 3 shows characters 125 can be attached to the top layer 105 of magnetic display system 120.

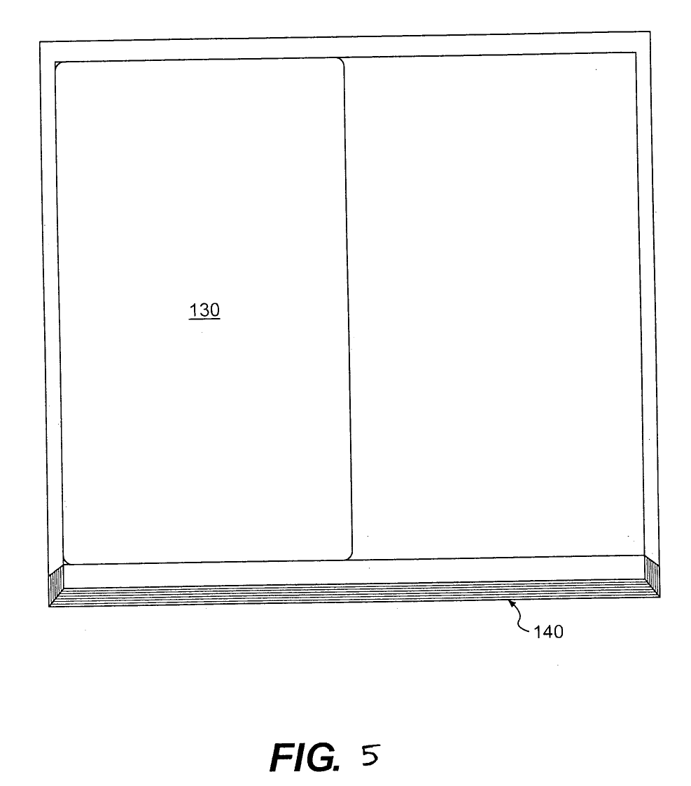

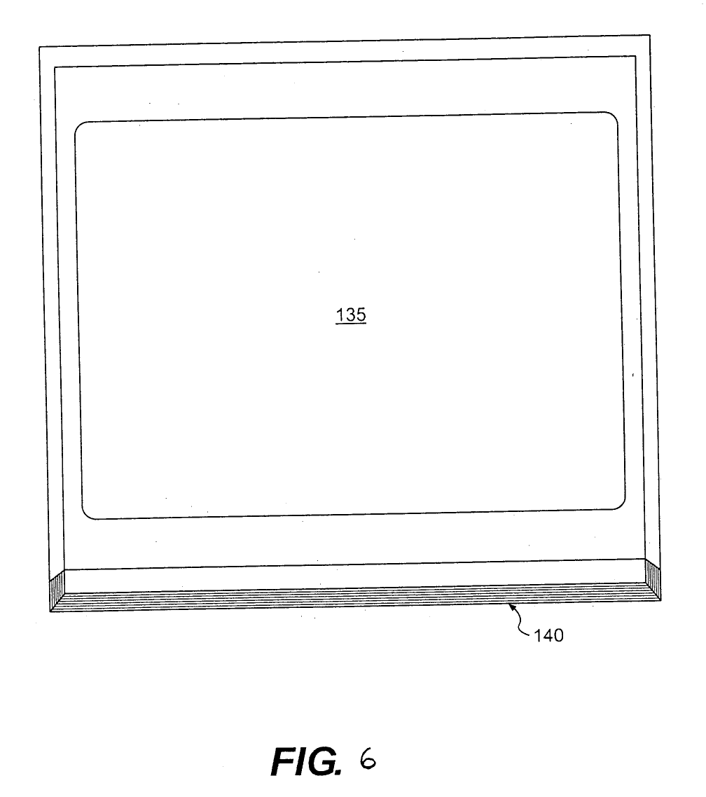

Turning to FIGS. 5 and 6, embodiments of a magnetic display system 130 and 135, respectively, are connected to a separate magnetic display system 140. As depicted in both FIGS. 4 and 5, the magnetic display systems 130 and 135 can connect to a separate magnetic display system 140 to cover a wide variety of spaces. For example, in FIG. 4, the magnetic display system 130 covers the left-hand portion of separate magnetic display system 140, while the right-hand side remains uncovered. This particular set-up gives an educator the option of using different modes of teaching simultaneously, without having to interchange equipment, or interchange boards. Such a setup can allow for an educator to use the magnetic display system 130 on the left-hand side, while also using the right-hand side of the separate magnetic display system with ease. As a non-limiting example, and to better illustrate this point, the magnetic display system 130 located on the left-hand side of the separate magnetic display system 140 can be utilized to tell a story by attaching characters 125 to top layer 105, while the right-hand side of the separate magnetic display system 140 can be written upon.

It is understood that the above descriptions are not, and should not be, limited solely to that explicitly shown in the figures. In the embodiments illustrated above, the magnetic display systems are constructed having three layers, however, it would be well within the scope and breath of this disclose to construct a magnetic display system having less than or more than three layers.

The top layer of the magnetic display system can be constructed in part, or in whole, from any suitable material, including, but not limited to, fabric(s), textile(s), metal(s), alloy(s), wood(s), porcelain, polymer(s), elastomer(s), or combinations thereof. In some embodiments the top layer can contain at least one fabric, textile, metal, alloy, wood, porcelain, polymer, or elastomer. In one embodiment the top layer of the magnetic display system is constructed in part, or in whole, from a pliable, soft material such as a fabric or textile material. Non-limiting examples of suitable fabrics or textile materials include, but are not limited to, flannel, felt, nylon, cotton, polyester, hook and loop material, and velvet. Non-limiting examples of other materials that can be utilized include, but are not limited to, latex, polyvinyl chloride, silicone, polyvinyl alcohol, chlorinated polyethylene resins, thermoplastics, and thermoset polymers. In another embodiment of the present inventive subject matter, the top layer comprises a fabric or textile, such as flannel or felt, which can hold a static electricity charge to aid in allowing characters to be placed and temporarily secured thereon. Additionally, the top layer can be constructed in part, or in whole, from cork, vinyl, rubber, recycled rubber, or combinations thereof.

The connecting middle section can be any suitable chemical composition, agent, mixture, emulsion, or adhesive, or mechanical device, which connects the top layer to the back layer. If the connecting middle section comprises a chemical substance, the chemical substance can be present in a continuous, or non-continuous, porous, or non-porous layer. Further, if the middle section comprises a chemical substance, the chemical substance can be present in separate or joined, connected or unconnected lines, dots, or other patterns. Preferably, the middle section comprises at least one chemical composition, agent, mixture, emulsion, or adhesive, or at least one mechanical device. Additionally, the middle section can be located in part, or wholly, around the perimeter of the magnetic display system.

One of the functions of the connecting middle section is to substantially connect the top layer to the back layer of the magnetic display system. Further, the connecting middle section does not have to be medially located wholly or in part between the top and back layers. It is within the scope and breath of this disclosure for the connecting middle section to include materials or entities located outside of the medial area of the top and back layers. As non-limiting examples, securing devices, such as but not limited to, nails, staples, and clamps can be located along the outer portions of the magnetic display system substantially securing the top layer to the back layer. Further, as a non-limiting example, an elastomer, polymer, or other material, such as those listed above either alone or in combination, can be located surrounding the peripheral edge of the magnetic display system substantially securing the top layer to the back layer.

Preferably the connecting middle layer is constructed in part, or in whole, of at least one chemical composition, agent, mixture, emulsion, or adhesive. In some embodiments of the present inventive subject matter the chemical composition can be any suitable adhesive, including but not limited to, a pressure sensitive adhesive. Further, the adhesive can contain at least one additional additive, including but not limited to, surfactant(s), dye(s), preservative(s), anti-oxidant(s), wetting agent(s), tackifier(s), and combinations thereof. The adhesive can be, but is not limited to, at least one adhesive dispersion, solids adhesive, solvent-borne adhesive, heat-activated adhesive, reactive adhesive, contact adhesive, hot-melt adhesive, spray adhesive, liquid adhesive, emulsion adhesive, rubber containing adhesive, acrylic containing adhesive, modified acrylic containing adhesive, polyurethane containing adhesive, polyvinyl acetate containing adhesive, polychloroprene containing adhesive, isocyanate containing adhesive, polyisocyanate containing adhesive, polyol containing adhesive, butyl rubber containing adhesive, ethylene vinyl acetate containing adhesive, or silicone containing adhesive. If the adhesive is a pressure sensitive adhesive, the pressure sensitive adhesive can be, but is not limited to, an acrylic containing, organosiloxane containing, methacrylic containing, epoxy containing, rubber containing, or cyanoacrylate containing pressure sensitive adhesive.

In one embodiment, the connecting middle layer comprises an adhesive, preferably an acrylic containing pressure sensitive, in a substantially continuous layer located between the top layer and the back layer of the magnetic display system.

The back layer of the magnetic display system can be rigid or flexible, with preferably the back layer being flexible. Further, the back layer can be constructed in part, or in whole, from any suitable magnetic or magnetizable material, or other materials including, but not limited to, fabric(s), textile(s), metal(s), alloy(s), wood(s), porcelain, polymer(s), plastic(s), plasticizer(s), elastomer(s), or combinations thereof. The back layer can comprise at least one magnetic, or magnetizable material. Magnetizable materials include materials which are not magnetic, however can be changed to have magnetic properties. Non-limiting examples of magnetic compositions which can be utilized in the back layer include, but are not limited to aluminum-nickel-cobalt compositions, neodymium-iron-boron compositions, samarium-cobalt compositions, strontium-ferrite compositions, ceramic compositions, and compositions containing rare-earth metals. In some embodiments, the back layer will contain at least some amount of iron in any chemical form.

Additionally, the back layer of the magnetic display system can be constructed in part from at least one pliable material. An example of a pliable material for use in the back layer includes the use of at least one polymer. The polymer(s) can be thermoplastic, thermoset, crystalline, amorphous, semi-crystalline, and elastomeric, and may contain magnetic and/or magentizable particles, pieces, or objects. Non-limiting examples of suitable polymer materials which can be utilized in the backing layer include, but are not limited to, ethylene vinyl alcohol, fluoroplastics, ionomers, polyacrylates, polybutadiene, polybutylene, polyethylene, polyethylenechlorinates, polymethylpentene, polypropylene, polystyrene, polyvinylchloride, polyvinylidene chloride, polyamide, polyamide-imide, polyaryletherketone, polycarbonate, polyketone, polyester, polyetheretherketone, polyetherimide, polyethersulfone, polyimide, polyphenylene oxide, polyphenylene sulfide, polyphthalamide, polysulfone, chlorinated polyethylene resin, allyl resin, melamine formaldehyde, phenol-formaldehyde plastic, silicone, polyurethane, epoxy, cellulosic, acrylonitrile-butadiene-styrene, liquid crystal polymer, polyacetal, polyacrylonitrile, thermoplastic elastomers, and diisodecyl phthalate.

In one embodiment, the back layer comprises a strontium ferrite composition, at least one chlorinated polyethylene resin, and diisodecyl phthalate.

In another embodiment, the amount of magnetic or magnetizable material(s) included in the back layer can range between about 10-100% in a weight-to-weight ratio of the total weight of the magnetic or magnetizable material(s), to the total weight of the back layer. In other embodiments, the amount of magnetic or magnetizable material(s) included in the back layer can range between about 25-99% in a weight-to-weight ratio of the total weight of the magnetic or magnetizable material(s), to the total weight of the back layer. In further embodiments, the amount of magnetic or magnetizable material(s) included in the back layer can range between about 50-98% in a weight-to-weight ratio of the total weight of the magnetic or magnetizable material(s), to the total weight of the back layer. Ideally, the amount of magnetic or magnetizable material(s) range between about 87-97% in a weight-to-weight ratio of the total weight of the magnetic or magnetizable material(s), to the total weight of the back layer.

In further embodiments, the amount of polymeric material(s) included the back layer can range between about 0.0-90% in a weight-to-weight ratio of the total weight of the polymeric material(s), to the total weight of the back layer. In other embodiments, the amount of polymeric material(s) included in the back layer can range between about 1-75% in a weight-to-weight ratio of the total weight of the polymeric material(s), to the total weight of the back layer. In another embodiment, the amount of polymeric material(s) included in the back layer can range between about 2-50% in a weight-to-weight ratio of the total weight of the polymeric material(s), to the total weight of the back layer. Ideally, the amount of polymeric material(s) range between about 5-15% in a weight-to-weight ratio of the total weight of the polymeric material(s), to the total weight of the back layer.

Additionally, the back layer can be constructed in part, or in whole, from a cellulose containing material, such as paper. Non-limiting examples of paper useful for the present subject matter include, but is not limited to, wax paper, asphalt paper, kraft liner, abrasive kraft, absorbent kraft, wet strength paper, parchment paper, gray chip, schrenz, testliner, volatile corrosion inhibitor paper, alkaline paper, anti-rust paper, antique paper, azurelaid paper, base paper, and combinations thereof. In an exemplary embodiment, the back layer can comprise paper with the paper having a release coating thereon, such that the release coating is between the paper back layer and middle section layer.

Moreover, the back layer can be removable or non-removable. In an embodiment, the back layer can be removable such that it can peel-off of the middle section, leaving the middle section substantially intact. In such an embodiment, the bond between the peel-off back layer and the middle section should be substantially less than the bond between the middle section and the top layer.

If back layer is removable, then a release coating can be on the back layer to decrease the bond between the back layer and the middle section. Release coating can be any suitable polymer, elastomer, or other material which reduces the bond strength between the back layer and the middle section to allow the back layer to be removed while the middle section remains substantially intact.

Tinting, pigments, or coloring agents can be added to the back layer for color effects. In some embodiments of the inventive subject matter the amounts of tinting, pigments, or coloring agents range between about 0.01-15% in a weight-to-weight ratio of the total weight of the tinting, pigment, or coloring agents, to the total weight of the back layer. In other embodiments, the amounts of tinting, pigments, or coloring agents range between about 1-10% in a weight-to-weight ratio of the total weight of the tinting, pigment, or coloring agents, to the total weight of the back layer. In further embodiments, the amounts of tinting, pigments, or coloring agents range between about 3-6% in a weight-to-weight ratio of the total weight of the tinting, pigment, or coloring agents, to the total weight of the back layer.

The magnetic display system can be connected to a surface by at least one mechanical device, chemical composition, agent, mixture, emulsion, or adhesive, or by magnetic force. In further exemplary embodiments, the magnetic display system can be connected to a surface by magnetic attraction of a back layer, which is connected to a top layer by a middle connecting section, to at least one portion of the surface. Non-limiting examples of surfaces to which the magnetic display system can be connected include chalkboards, dry erase boards, walls, and the like. As a non-limiting example, and to further illustrate how a exemplary magnetic display system can be connected to a surface, an exemplary magnetic display system having a magnetic back layer can be placed against a surface having a magnetic field, with the magnetic back layer of the display system being attracted to the surface. Upon contact, the exemplary magnetic display system can connect to the surface having the magnetic field, and remained connected to the surface until it is forcibly removed.

Further, the magnetic display system can be designed in any desired shape or form to cover any desired size and shape area.

In one embodiment of a magnetic display system, the top layer includes a fabric material, such as flannel or felt, the middle connecting section includes an acrylic containing pressure sensitive adhesive in a substantially continous layer, and the back layer includes a magnetic, iron containing composition, and a polymeric material.

Characters 125, as shown in FIG. 3, can be designed to attach to the top layer of the magnetic display system. Characters can be constructed in part, or in whole, from any suitable material, including, but not limited to, fabric(s), textile(s), metal(s), alloy(s), wood(s), porcelain, polymer(s), elastomer(s), plastic(s), or combinations thereof. The characters in one embodiment include at least one fabric, textile, metal, alloy, wood, porcelain, polymer, plastic, or elastomer. In an exemplary embodiment, the characters are constructed in part, or in whole, from a pliable, soft material such as a fabric or textile material. Non-limiting examples of suitable fabrics or textile materials include, but are not limited to, flannel, felt, nylon, cotton, polyester, hook and loop material, and velvet. Non-limiting examples of other materials that can be utilized include, but are not limited to, latex, polyvinyl chloride, silicone, polyvinyl alcohol, chlorinated polyethylene resins, thermoplastics, and thermoset polymers. In other embodiments, the characters include a fabric or textile, such as flannel or felt, which can hold a static electricity charge to aid in allowing characters to be placed and temporarily secured on the top layer of the magnetic display device.

Further, the characters can include at least one magnetic, or magnetizable material to aid, promote, and/or necessitate the characters to attach to the top layer of the magnetic display system.

In certain embodiments of the inventive subject matter, a magnetic display system, including all of the embodiments described herein, is attached to a surface such as a chalkboard, a dry erase board, or other magnetic surface by placing the back layer of the magnetic display system flush against the surface to which the display system is desired to be attached, and remains connected to the surface by magnetic force. After placing the back layer flush against the surface to which the magnetic display system is to be attached, the top layer will be planar to the surface upon which the display system is attached. Characters, as previous described and depicted, can be attached to the top layer for teaching or learning exercises.

Additionally, an embodiment of a magnetic display system comprising a middle section 110 comprising an adhesive connected to a back layer 115 forming a lower di-layered sheet 150 can be produced by conventional means well known in the art. Additionally, such a conventional means includes, but is not limited to, spray coating middle section 110 onto back layer 115. The middle section 110 is preferably evenly dispersed on the back layer 115.

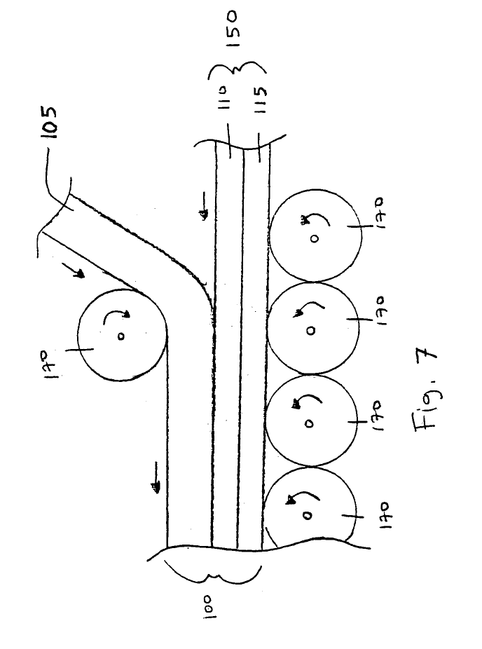

The lower di-layered sheet 150 and a top layer 105 can be substantially connected together by a connecting process. A non-limiting example of connecting process includes lamination processes, as illustrated in FIG. 7. Non-limiting examples of lamination processes useful for producing the present subject matter include flame lamination, hot roll lamination, cold lamination, belt lamination, calender lamination, and sheet extrusion.

In an embodiment of the present inventive subject matter, the lower di-layered sheet 150 is laminated onto the top layer 105 by heating the lower di-layered sheet 150, and then press fitting the lower di-layered sheet 150 onto the top layer 105. The lower di-layered sheet 150 can be heated by at least one roller 170 of the lamination apparatus. The strength of the bond between the lower di-layered sheet 150 and the top layer 105, can be controlled by the tension applied to both the lower di-layered sheet 150 and the top layer 105 by at least one roller 170 of a lamination apparatus. In an exemplary process, the AGL 64T laminator by Advanced Greig Laminators, Inc. can be used as a lamination apparatus. In an embodiment, the lamination process connects the lower di-layered sheet 150 to the top layer 105 such that the bond between the lower di-layered sheet 150 and top layer 105 is greater than the bond between the middle section 110 and back layer 115. In another embodiment, the lamination process connects the lower di-layered sheet 150 to the top layer 105 such that the bond between the lower di-layered sheet 150 and top layer 105, and the bond between the middle section 110 and the back layer 115 are substantially indestructible under normal usage conditions.

Further, the lamination process of the present subject matter increases the integrity of the bond between the lower di-layered sheet 150 and the top layer 105. As a non-limiting example, the lamination process of the present invention produces a lower di-layered sheet 150 laminated to a top layer 105 such that the bond between the middle section 110 and the top layer 105 is greater than the bond between the middle section 110 and the back layer 115.

Additionally, the bond integrity between the lower di-layered sheet and the top layer is an important aspect of the present subject matter. The lamination process of the present subject matter additionally reduces undesirable effects between the lower di-layered sheet and the top layer. Such undesirable effects include but are not limited to excessive bubbling, weakened bond strength, and warping between the middle section and the top layer.

The below illustrative examples are exemplary embodiments of the present inventive subject matter, and in no way should be construed as limiting the scope and breadth of the current disclosure.

### EXAMPLE 1

A magnetic display system 100 comprising a top layer 105 constructed of cork is connected to a flexible magnetic back layer 115 by middle section 110 comprising a pressure sensitive adhesive.

### EXAMPLE 2

A magnetic display system 100 comprising a top layer 105 constructed of vinyl is connected to a flexible magnetic back layer 115 by middle section 110 comprising a pressure sensitive adhesive.

### EXAMPLE 3

A magnetic display system 100 comprising a top layer 105 constructed of rubber is connected to a flexible magnetic back layer 115 by middle section 110 comprising a pressure sensitive adhesive.

### EXAMPLE 4

A magnetic display system 100 comprising a top layer 105 constructed of cork is connected to a peel-off back layer 115 constructed of paper and having a release coating 113 thereon by middle section 110 comprising a pressure sensitive adhesive.

### EXAMPLE 5

A magnetic display system 100 comprising a top layer 105 constructed of vinyl is connected to a peel-off back layer 115 constructed of paper and having a release coating 113 thereon by middle section 110 comprising a pressure sensitive adhesive.

### EXAMPLE 6

A magnetic display system 100 comprising a top layer 105 constructed of rubber is connected to a peel-off back layer 115 constructed of paper and having a release coating 113 thereon by middle section 110 comprising a pressure sensitive adhesive.

### EXAMPLE 7

A magnetic display system 100 comprising a top layer 105 constructed of cork, vinyl, rubber, recycled rubber, or a combination thereof, a middle section 110 constructed of an adhesive, and a back layer 115 constructed of a flexible magnetic backing is assembled by laminating the top layer 105 to a lower di-layered sheet 150 comprising the middle section 110 and the back layer 115. The bond between the top layer 105 and middle section 110, and the bond between the middle section 110 and back layer 115 are both substantially indestructible under normal usage conditions.

### EXAMPLE 8

A magnetic display system 100 comprising a top layer 105 constructed of cork, vinyl, rubber, recycled rubber, or a combination thereof, a middle section 110 constructed of an adhesive, and a back layer 115 constructed paper having a release coating 113 thereon is assembled by laminating the top layer 105 to a lower di-layered sheet 150 comprising the middle section 110 and the back layer 115. The bond between the top layer 105 and middle section 110 is greater than the bond between the middle section 110 and back layer 115, such that the back layer 115 can be removed while middle section 110 remains substantially intact.

The present invention has been described with respect to preferred selected embodiments, and several alternative embodiments thereof. However, other embodiments would be obvious to those skilled in the art without departing from the spirit and scope of the appended claims.

We claim:

1) A display system comprising:
a top layer,
a middle section connected to the top layer, and
a back layer connected to the middle section,
wherein the top layer comprises at least one material selected from the group consisting of cork, vinyl, rubber, recycled rubber, and combinations thereof, and the back layer comprises a magnetic material.

2) The display system of claim 1 wherein the middle section is an adhesive.

3) The display system of claim 2, wherein the adhesive is an acrylic containing pressure sensitive adhesive.

4) The display system of claim 1, wherein the back layer comprises at least one chemical form of iron.

5) The display system of claim 1, wherein the back layer comprises at least one magnetic material selected from the group consisting of: a strontium ferrite composition, an aluminum-nickel-cobalt composition, a neodymium-iron-boron composition, a samarium-cobalt composition, a ceramic composition, a rare-earth metal composition, and combinations thereof.

6) The display system of claim 1, wherein the back layer comprises at least one polymer, elastomer, plastic, or plasticizer.

7) The display system of claim 6, wherein the polymer is at least one thermoset polymer or thermoplastic polymer.

8) The display system of claim 1, wherein the back layer comprises at least one material selected from the group consisting of: ethylene vinyl alcohol, fluoroplastics, ionomers, polyacrylates, polybutadiene, polybutylene, polyethylene, polyethylenechlorinates, polymethylpentene, polypropylene, polystyrene, polyvinylchloride, polyvinylidene chloride, polyamide, polyamide-imide, polyaryletherketone, polycarbonate, polyketone, polyester, polyetheretherketone, polyetherimide, polyethersulfone, polyimide, polyphenylene oxide, polyphenylene sulfide, polyphthalamide, polysulfone, chlorinated polyethylene resin, allyl resin, melamine formaldehyde, phenol-formaldehyde plastic, silicone, polyurethane, epoxy, cellulosic, acrylonitrile-butadiene-styrene, liquid crystal polymer, polyacetal, polyacrylonitrile, thermoplastic elastomers, diisodecyl phthalate, and combinations thereof.

9) A display system comprising:
a top layer,
a middle section connected to the top layer, and
a back layer connected to the middle section,
wherein the top layer comprises at least one material selected from the group consisting of cork, vinyl, rubber, recycled rubber, and combinations thereof, and the back layer comprises a peel-off backing layer.

10) The display system of claim 9 wherein the middle section is an adhesive.

11) The display system of claim 10, wherein the adhesive is an acrylic containing pressure sensitive adhesive.

12) The display system of claim 9, wherein the peel-off backing layer comprises at least one material selected from the group consisting of a cellulose containing material, a polymer, and combinations thereof.

13) The display system of claim 12, wherein said cellulose containing material is paper.

14) The display system of claim 12, wherein said polymer is selected from the group consisting of at least one crystalline polymer, amorphous polymer, semi-crystalline polymer, thermoset polymer, thermoplastic polymer, elastomer polymer, and combinations thereof.

15) A display system comprising:
a top layer,
a middle section,
and a peel-off back layer connected to said middle section,
wherein said middle section connected to said peel-off back layer is laminated to said top layer such that a bond between said top layer and said middle section is greater than a bond between said middle section and said peel-off back layer.

16) The display system of claim 15, wherein said top layer comprises at least one material selected from the group consisting of cork, vinyl, rubber, recycled rubber, and combinations thereof.

17) The display system of claim 15, wherein said middle section comprises at least one adhesive.

18) The display system of claim 17, wherein said adhesive is a pressure-sensitive adhesive.

19) The display system of claim 15, wherein said back layer comprises at least one material selected from the group consisting of a cellulose containing material, a polymer, and combinations thereof.
